(19) United States
(12) Patent Application Publication
(10) Pub. No.: US 2021/0395647 A1
(43) Pub. Date: Dec. 23, 2021

(54) A QUICK AND EASY CLEANING FORMULATION

(71) Applicant: Conopco, Inc., d/b/a UNILEVER, Englewood Cliffs, NJ (US)

(72) Inventors: Koushik Acharya, Bangalore (IN); Sarmistha Biswas, Bangalore (IN); Bijal Dharmvirbhai Shah, Bangalore (IN); Jayashree Anantharam Vadhyar, Bangalore (IN)

(21) Appl. No.: 17/273,654

(22) PCT Filed: Jul. 24, 2019
(86) PCT No.: PCT/EP2019/069966

§ 371 Date: Mar. 4, 2021

(30) Foreign Application Priority Data
Sep. 5, 2018 (EP) 18192726.0

(51) Int. Cl. C11D 3/20; C11D 1/83; C11D 11/00; C11D 3/43; C11D 3/48; C11D 1/72; C11D 3/36; C11D 1/29; C11D 17/00

(52) U.S. Cl. CPC C11D 3/2068; C11D 1/83; C11D 11/0017; C11D 3/43; C11D 3/48; C11D 3/2044; C11D 17/0008; C11D 3/2086; C11D 3/2082; C11D 1/72; C11D 3/361; C11D 1/29; C11D 3/2093

(57) ABSTRACT

The present invention relates to a composition and a method for delaying laundry. The present invention provides a fabric treatment composition comprising: a solvent system in combination with surfactants, a hydrotrope, and a sequestrant, wherein the composition has a pH ranging from 2.5 to 5.0. The solvent system comprises a glycol ether; a diol; and a fatty acid ester. The composition of the present invention provides cleaning and anti-microbial benefits when used on a substrate.

### FIELD OF THE INVENTION

The present invention relates to a composition and a method for treating substrates, such as fabrics. In particular, the present invention pertains to a composition which can deliver cleaning, and anti-microbial benefit to fabrics, thereby delaying laundry.

### BACKGROUND OF THE INVENTION

Washing processes, including laundry, dishwashing and other household cleaning processes, require large volumes of water throughout the world. The use of detergents for laundry consume a large amount of water and currently it is almost impossible to clean fabrics without the use of detergents. Water is becoming, more and more, a scarcely available commodity. One way of saving water is to reuse the water and another way is to reduce the amount of water being used. In both D and D&E world, 40% of wash load is not at all dirty, it only needs freshening up. Besides, frequent washing makes clothes limp and dull. Therefore, there is a long-felt need for compositions which can clean, and/or freshen the fabric, and deliver anti-microbial benefits using little or no water.

WO 03/044149 (Unilever) discloses a process of cleaning a substrate, the process comprising the steps of contacting a substrate with a composition comprising at least two liquids mutually presenting a liquid-liquid interface with an interfacial tension of at least 5 mN/m and agitating the substrate and/or composition whilst they are in mutual contact, wherein the composition and/or the substrate are also subjected to ultrasound before and/or during the agitation step. This composition does not comprise a bipolar antimicrobial particle

Previously filed Unilever patent PCT/EP2017/052541 is a formulation comprising of a solvent system comprising Methyl Laurate, Dipropylene glycol n-Butyl Ether, and Octane diol. CPC clay is added to provide the antimicrobial benefit. This formulation is effective in solubilizing and removing fatty/oily stain as well as providing a hygiene benefit. However, the formulation disclosed has numerous disadvantages, including instability in hot and dry conditions; the need for a specific order of addition and mixing conditions that make the processing challenging; a high viscosity which makes the formulation hard to spray; and finally gross negative ashing or patching due to the presence of CPC clay.

It is an object of the invention to provide a composition for laundering of fabrics which while reducing the requirement for water can deliver cleaning and anti-microbial benefit through one product and is devoid of the aforementioned disadvantages.

It is therefore an object of the present invention to delay laundry.

Surprisingly, it has been found that cleaning and anti-microbial benefits on fabric can be achieved by a solvent mix of a diol, a fatty acid ester and a glycol ether in combination with surfactants, sequestrants, and a hydrotrope.

### SUMMARY OF THE INVENTION

Accordingly, in a first aspect, the invention provides a fabric treatment composition comprising:
i. 1 to 35% by weight of a solvent system comprising
   (a) 2 to 66% by weight of a glycol ether;
   (b) 0.8% to 25% by weight of a diol which is a vicinal diol with carbon chain length from C₇ to C₁₄;
   (c) 2% to 66% by weight of a fatty acid ester of the formula R¹C(═O)OR² wherein R¹ represents an alkyl group having 6 to 15 carbon atoms and R² is preferably a methyl or ethyl; and
ii. 0.25% to 10% by weight of an alkoxylated 08-18 anionic surfactant;
iii. 0.75%% to 27% by weight of a nonionic surfactant selected from alkoxylated alkanols in which the alkanol comprises 9 to 20 carbon atoms and wherein the number of moles of 02-3 alkylene oxide is from 5 to 20;
iv. 0.1% to 20% by weight of a hydrotrope selected from 1,2 propanediol, polypropylene glycol and combinations thereof;
v. 0.1% to 2% by weight of a phosphonate based sequestrant;
vi. 0.5% to 2% by weight of sodium citrate; and
vii. water,
wherein the composition has a pH ranging from 2.5 to 5.0.

In a second aspect, the invention provides a method for treating a fabric comprising the steps in sequence of applying the composition of the present invention onto the fabric; rinsing the fabric with water at least once; and allowing the fabric to dry.

In a third aspect, the invention provides the use of the composition according to the invention for cleaning fabric and for delivering antimicrobial benefits to fabric.

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

### DETAILED DESCRIPTION OF THE INVENTION

Unless otherwise specified, all percentages, ratios or parts herein are on a weight basis. The term “wt %” as used herein is an abbreviation of “% by weight”.

The present invention provides a composition for treating fabric, comprising a solvent mix in combination with anionic surfactant and nonionic surfactants. The composition of the present invention further comprises a hydrotrope and a sequestrant. The balance of the composition is made up to 100% by weight with water.

The present invention offers a quick and effective solution for freshening up, and/or cleaning fabrics/clothes, while also delivering an antimicrobial benefit, in just three steps: spray, dip and dry. The compositions and methods of the present invention clean up dirt and stains, eliminate malodour and kill germs, saves time and effort, while using 70% less water as compared to a conventional wash or laundry process.

It has been observed that a consumer's perception of a high amount of foam generated during the laundry process correlates with a higher utilization of water, especially at the rinse stage of laundry. The composition disclosed herein further comprises a combination of nonionic surfactant, anionic surfactant and a hydrotrope. The hydrotrope may be selected from 1,2 propane diol, polypropylene glycol and combinations thereof, which provide best stabilization of the resulting formulation with the least generation of foam so that the water consumption is kept at the minimum.

Additionally, the formulation disclosed herein has a sequestrant and sodium citrate that further enhance the cleaning and hygiene benefit. The liquid composition when formulated without sodium citrate has an acidic pH (˜1), due to the sequestrant, and thus needs to be adjusted to a pH in the range of 2.5-5.0. Addition of a buffer, specifically sodium citrate allows for the pH adjustment and stability of the pH, thereby enhancing shelf life.

Accordingly, in a first aspect the invention provides a fabric treatment composition comprising:
(i) 1 to 35% by weight of a solvent system comprising
   (a) 2 to 66% by weight of a glycol ether;
   (b) 0.8% to 25% by weight of a diol which is a vicinal diol with carbon chain length from C₇ to C₁₄;
   (c) 2% to 66% by weight of a fatty acid ester of the formula R¹C(═O)OR² wherein R¹ represents an alkyl group having 6 to 15 carbon atoms and R² is preferably a methyl or ethyl; and
(ii) 0.25% to 10% by weight of an alkoxylated 08-18 anionic surfactant;
(iii) 0.75%% to 27% by weight of a nonionic surfactant selected from alkoxylated alkanols in which the alkanol comprises 9 to 20 carbon atoms and wherein the number of moles of 02-3 alkylene oxide is from 5 to 20;
(iv) 0.1% to 20% by weight of a hydrotrope selected from 1,2 propanediol, polypropylene glycol and combinations thereof;
(v) 0.1% to 2% by weight of a phosphonate based sequestrant;
(vi) 0.5% to 2% by weight of sodium citrate; and
(vii) water,
wherein the composition has a pH ranging from 2.5 to 5.0.

According to a particularly preferred embodiment, the fabric treatment composition is a liquid composition.

The treatment composition preferably has a pH of not more than 4.5, more preferably of not more than 4.0.

Solvent System

The aqueous composition of the present invention comprises a solvent system comprising a diol, a fatty acid ester and a glycol ether.

Diol:

The diol used in the present invention are vicinal diols with carbon chain lengths from C₇ to C₁₄ which includes 1,2-heptanediol, 1,2-nonanediol, 1,2-decanediol, 1,2-dodecanediol, 1,2-tetradecanediol. Preferably, the diol is selected from 1,2 octanediol, 1,2-nonanediol, 1,2-decanediol and combinations thereof.

Preferred diol is 1,2 octanediol due to its superior performance in combination with glycol ether, fatty acid ester and the bipolar antimicrobial particle.

The diol is preferably present in a concentration of 0.1 to 4% by weight of the treatment composition, still more preferably 0.2 to 2% by weight of the treatment composition.

The diol preferably constitutes 3-30%, more preferably 6-25% by weight of the solvent system.

Glycol Ether:

Glycol ether of the present invention includes materials such as DOWANOL™ (trademark of The Dow Chemical Company) P and E series including both water soluble and water insoluble glycol ether or glycol ether ester, ethylene glycol mono n-butyl ether, ethylene glycol monomethyl ether, propylene glycol monomethyl ether, propylene glycol mono n-butyl ether (PnB), dipropylene glycol monomethyl ether, dipropylene glycol mono propyl ether (DPnP), dipropylene glycol mono n-butyl ether (DPnB), and diethylene glycol butyl ether (DB), propylene glycol mono phenyl ether, propylene glycol monomethyl ether acetate. However, P series glycol ethers are more preferred over E-series as they are more environmentally safe.

Preferred glycol ethers are selected basis Hansen solubility parameter. If the target soil is considered as body fluid or sebum or common oily/fatty stains such as cooking oil/DMO, the glycol ethers whose RED is (RED means relative energy difference in HSP space) less than 2 against these soils have been proven to show efficacy. RED i.e. relative energy differences, indicates the extent of solubility of a solute in a particular solvent. RED is a unit less number which is essentially the ratio of Rₐ/R₀. In 3 coordinate system R₀ is defined as the maximum interaction radius of a solute and Rₐ is defined as the interaction radius for the respective solvent. RED is calculated using solubility parameters which consists of polar, dispersion and hydrogen bonding component of intermolecular interactions pertaining to both solvent and solute.

Dipropyleneglycol n-butyl ether, Dipropyleneglycol dimethyl ether and dipropyleneglycol methyl ether acetate, diethyleneglycol monohexyl ether (hexyl carbitol) are the most preferred.

The glycol ether is preferably present in a concentration of 0.1% to 20% by weight of the treatment composition, more preferably 0.3% to 10% by weight of the treatment composition.

The glycol ether preferably constitutes 10-60%, more preferably 20-55% by weight of the solvent system.

Fatty Acid Ester:

Fatty acid ester of the present invention is of the formula:

R¹C(═O)OR²

wherein R¹ represents an alkyl group having 6-15 carbon atoms and R² is preferably a methyl or ethyl.

The preferred esters are those where R¹⁰⁰ is relatively long chain fatty acyl group, i.e. where R¹ has 7 to 13 carbon atoms. In these compounds R² is preferably a methyl radical.

Particularly preferred due to its performance and availability are methyl laurate and olefinic methyl laurate i.e. methyl dodec-9-enoate.

The fatty acid ester is preferably present in a concentration of 0.1% to 20% by weight of the treatment composition, more preferably 0.3% to 10% by weight of the treatment composition.

The fatty acid ester preferably constitutes 10-60%, more preferably 15-55% by weight of the solvent system.

The solvent mix is preferably present in the treatment composition in a concentration of 1 to 20% by weight, preferably not less than 15% by weight, more preferably more than 10% by weight, still more preferably not more than 5% by weight.

Water

The composition of the present invention is an aqueous composition comprising water. The composition is made up to 100 percent by adding water. The composition preferably comprises 40 to 97% by weight of water.

The composition of the present invention comprises of sodium citrate in the rage of 0.5% to 2% to get the product pH of 2.5 to 5.0.

Surfactant

Alkoxylated C₈₋₁₈ Anionic Surfactant

The liquid cleaning composition of the present invention preferably comprises 1 to 10 wt % alkoxylated anionic surfactant.

The alkoxylated anionic surfactant has an alkyl group with carbon chain length C₈-18 and preferably comprises 1 to 30 moles of alkylene oxide.

This surfactant may have a normal or branched chain alkyl group containing lower ethoxy groups with two or three carbon atoms. A general formula of such surfactants is RO(C₂H₄O)ₓ, SO₃⁻M⁺ where R is an alkyl chain having from 10 to 22 carbon atoms, saturated or unsaturated, M is a cation which makes the compound water-soluble, especially an alkali metal, ammonium or substituted ammonium cation, and x averages from 1 to 15. Preferably R is an alkyl chain having from 8 to 18 carbon atoms, more preferably 8 to 16 carbon atoms, M is sodium and x averages from 1 to 3, more preferably x is 1.

It is particularly preferred that the alkoxylated anionic surfactant is an ethoxylated anionic surfactant which is preferably sodium lauryl ether sulphate (SLES). It is the sodium salt of lauryl ether sulphonic acid in which the predominantly C12 lauryl alkyl group is ethoxylated with an average of 1 to 30 moles of ethylene oxide per mole, more preferably 1 to 15 moles of ethylene oxide per mole, still more preferably 1 to 7 moles of ethylene oxide per mole of SLES.

Other examples of suitable ethoxylated anionic surfactants that could be used in accordance with the present invention are C₁₂ to C₁₅ normal or primary alkyl triethoxy sulphate, sodium salt; n-decyl diethoxy sulphate, sodium salt; C₁₂ primary alkyl diethoxy sulphate, ammonium salt; C₁₂ primary alkyl triethoxy sulfate, sodium salt; C₁₅ primary alkyl tetraethoxy sulfate, sodium salt; mixed C₁₄ to C₁₅ normal primary alkyl mixed tri- and tetraethoxy sulfate, sodium salt; stearyl pentaethoxy sulfate, sodium salt; and mixed C₁₀ to C₁₅ normal primary alkyl triethoxy sulfate, potassium salt.

The liquid composition according to the present invention preferably includes 1 wt % to 10 wt % of the alkoxylated anionic surfactant. The liquid composition preferably contains at least 1 wt %, more preferably 1 to 5 wt % of ethoxylated C₈₋₁₈ alkyl ether sulfate surfactant having 1 to 30 moles of ethylene oxide.

Preferably the amount of alkoxylated anionic surfactant in the liquid cleaning composition of the present invention is at least 1 wt %, still preferably at least 2.5 wt %, further preferably at least 3 wt % and most preferably at least 5 wt %, but typically not more than 10 wt %.

Non-Ionic Surfactant

The foamable liquid cleaning composition of the present invention preferably comprises 1 wt % to 15 wt % of the non-ionic surfactant. Nonionic surfactants are characterized by the presence of a hydrophobic group and an organic hydrophilic group and are typically produced by condensation of an organic aliphatic or alkyl aromatic hydrophobic compound with ethylene oxide.

The nonionic surfactant employed in accordance with the invention is selected from alkoxylated alkanols in which the alkanol is of 9 to 20 carbon atoms and wherein the number of moles of alkylene oxide (of 2 or 3 carbon atoms) is from 5 to 20. Of such materials, it is preferred to use those wherein the alkanol is a fatty alcohol of 9 to 11 or 12 to 15 carbon atoms and which contain from 5 to 8 or 5 to 9 alkoxy groups per mole. Also preferred are paraffin-based alcohols (e.g. nonionic surfactants from Huntsman or Sassol). Preferably the non-ionic surfactant is selected from an alkoxylated linear alcohol, more preferably an ethoxylated linear alcohol.

Exemplary of such compounds are those in which the alkanol is of 10 to 15 carbon atoms and which contain about 5 to 12 ethylene oxide groups per mole, e.g. Neodol™ family, Tergitol 15-S-7 etc. These are condensation products of a mixture of higher fatty alcohols averaging about 12 to 15 carbon atoms with about 9 moles of ethylene oxide. The higher alcohols are primary alkanols.

Another subclass of alkoxylated surfactants which may be used contain a precise alkyl chain length rather than an alkyl chain distribution of the alkoxylated surfactants. Typically, these are referred to as narrow range alkoxylates. Examples of these include the Neodol™-1 series of surfactants.

Other useful non-ionic surfactants are represented by the commercially well-known class of non-ionic surfactants sold under the trademark Plurafac™ from BASF. The Plurafac™ are the reaction products of a higher linear alcohol and a mixture of ethylene and propylene oxides, containing a mixed chain of ethylene oxide and propylene oxide, terminated by a hydroxyl group. Examples include C13-C15 fatty alcohols condensed with 6 moles ethylene oxide and 3 moles propylene oxide, C13-C15 fatty alcohol condensed with 7 moles propylene oxide and 4 moles ethylene oxide, C13-C15 fatty alcohol condensed with 5 moles propylene oxide and 10 moles ethylene oxide or mixtures of any of the above.

Another group of nonionic surfactants are commercially available as Dobanol™ which is an ethoxylated C₁₂-C₁₅ fatty alcohol with an average of 7 moles ethylene oxide per mole of fatty alcohol.

Preferably the amount of nonionic surfactant in the liquid cleaning composition is at least 1 wt %, still preferably at least 3 wt %, further preferably at least 4 wt % and most preferably at least 5 wt %, but typically not more than 20 wt %, still preferably not more than 15 wt % and most preferably not more than 12 wt % based on the liquid cleaning composition.

Surfactant to Solvent ratio

The preferred surfactant to solvent ratio is 20:1. More preferably 8:1 and most preferably 1:1 to 4:1.

Hydrotropes

The hydrotrope is selected from 1,2 propane diol polypropylene glycol; and combinations thereof. Preferably, the hydrotrope is 1,2 propanediol. Preferably, the amount of hydrotrope is in the range of 0.1% to 20% by weight of the composition, more preferably in the range of 1% to 16% by weight of the composition, most preferably in the range of 2% to 12% by weight of the composition.

Sequestrant

The presence of phosphonate based sequestrants improves cleaning performance. It is believed that these components sequester weakly bound calcium ions as well as certain transition metal ions like Fe³⁺ ions which are involved in the attachment of soil to surfaces and thereby facilitate the removal of these soils.

Sequestrants such as EDTA are less suitable for environmental reasons, as it has been suggested that such poorly biodegradable sequestrants can solubilise heavy metals from river-bottom deposits. Moreover, EDTA and other strong sequestrants have a tendency to complex with the calcium present in the domestic water and prevent the formation of the defoaming calcium soap.

Preferably, the phosphonate based sequestrant is selected from, 1-hydroxyl ethylidene-1,1-diphosphonic acid, 1-hydroxyl ethylidene-1,1-diphosphonic acid sodium salt, ethylidenediamine tris(methylene phosphonic acid, hydroxyethylidene-1,1-diphosphonic acid, and sodium salts thereof. Most preferably, the phosphonate based sequestrant is selected from 1-hydroxyl ethylidene-1,1-diphosphonic acid, 1-hydroxyl ethylidene-1,1-diphosphonic acid sodium salt, ethylidenediamine tris(methylene phosphonic acid and hydroxyethylidene-1,1-diphosphonic acid.

Typical levels of the sequestrant range from 0.5 to 10% wt, preferably 1 to 4% wt by weight of the liquid composition. Most preferably, the sequestrant level ranges from 0.5% to 2% by weight of the liquid composition.

Optional Ingredients

The cleaning composition may comprise additional ingredients such as polymeric emulsifiers, SRPs (soil release polymers), perfumes, preservatives, brighteners, salt to control viscosity, pH adjusters or buffers, enzymes etc.

Polymeric emulsifier used in the present invention included Pemulene and Novemer EC2 (procured from Lubrizol). These are the high molecular weight polyacrylates which has both hydrophobic and hydrophilic moiety present.

The soil release polymers (SRPs) used in the present invention include neodol (as supplied by Shell or Clariant) and Texcare SRN UL. These provide a cleaning benefit.

The composition of the present invention may also include optional ingredients like perfumes, preservatives, brighteners, salt to control viscosity, pH adjusters or buffers, enzymes etc.

Process for Treating a Fabric

In a second aspect, the invention relates to a method for treating a fabric comprising the steps in sequence of applying the composition according to the invention onto a fabric, providing required agitation as applicable followed by rinsing the fabric at least once with water; and allowing the fabric to dry.

The composition may be applied by any known method such as by using wipes, spray, including spray guns, atomizers, or other direct application.

Optionally, the fabric may be rinsed after the application of the composition and before drying.

Use of the Composition

In a third aspect, the invention relates to the use of the composition according to the invention for cleaning fabric and for delivering antimicrobial benefits to fabric.

Product Format

The formulation can be in three formats: spray, foam and wipe. Spray and Foam can be applied to the problem area e.g. underarm, collar/cuff or can be applied to entire fabric. This would provide antimicrobial benefit and deliver perfume. For the wipe format, formulation needs to be loaded on non-woven fabric made of polypropylene. This can be applied and rubbed on directly to the soil/stained areas. This application would provide cleaning, anti-microbial benefit as well as deliver perfume. The viscosity of the aforesaid composition must be below 100 cP for it to foam and spray.

The invention is further illustrated by the following non-limiting examples.

### EXAMPLES

Materials

Non-ionic surfactant (C₁₂E_{O7}) and alkoxylated 08-18 anionic surfactant were procured from Galaxy surfactant. Octane diol solvent was procured from Avara synthesis and dipropylene glycol n-butyl ether was procured from Sigma Aldrich or from Dow chemicals. Methyl laurate was procured form Sigma Aldrich and KLK. Sodium citrate and propane 1,2 diol were procured from Merck. Texcare UL 50 was procured from Clariant. Perfume Safari sake 4F was procured from Givaudan perfumery house. Dequest 2010 was procured form Italmach chemicals.

Preparation of the Composition and the Order of Addition

The formulation was prepared using an overhead stirrer in laboratory. For making 11 of the formulation, 776 ml of water was taken in the beaker. Stirrer speed was kept constant at 185 rpm. 30 g of the non-ionic surfactant was added into the water and stirring was continued till dissolved. 14.29 g of SLES was added after that and mixed thoroughly till completely dissolved. In a different beaker, 5 g of 1,2 octane diol, 25 g of dipropylene glycol n-butyl ether and 10 g of methyl laurate was weighed. The solvent mix was added slowly into the main formulation with continued stirring till a clear solution appears. Subsequently, 80 g of 1,2 propane diol was added to the solvent mix. Following this, 20.80 g of Texcare UL 50 and 16.67 g of Dequest 2010 were added and mixed to achieve complete dissolution, which brought the pH of the solution to 1.5. 20 g sodium citrate was added to bring the pH to 4-4.5.

Procedure for Soiling the Fabric:

Procedure for Soiling the Fabric:

The cleaning benefit was evaluated on re-wear stains such as, Black tea, coffee with milk, tomato ketchup and garden soil. Staining protocol for all the stains are given below.

Preparation of Black tea stain: 2 tea (Tajmahal Brand-Unilever) bags were dipped into 100 ml of hot water, till a tea infusion was achieved. Following this, tea bags were removed. 0.2 ml of the tea infusion was applied directly onto a fabric of 10 cm*10 cm size to achieve the desired stain.

Preparation of coffee with milk stain: In a ¼ cup of hot water Bru instant coffee was dissolved and to this ¾ cup of hot milk was added from the vending machine. 0.2 ml of the prepared coffee with milk was applied, through 1 ml pipette, directly onto the fabric of 10 cm*10 cm size to achieve the desired stain.

Garden Soil: A solution containing 50% Bangalore mud sample and 50% water was prepared. The solution was stirred well to get a homogeneous mixture. 0.2 ml of the aforementioned solution was applied directly onto the fabric of 10 cm*10 cm size to achieve the desired stain. Alternatively, the solution could be rubbed on to the fabric with a spatula to make a circle.

Tomato ketchup: Kissan tomato ketchup was used. Ketchup was taken in a small spatula (around 0.2 g), and applied onto the fabric and the application rubbed to get a circular stain.

Cooking oil: 100 ml of sunflower oil was mixed with 0.1 g of soil soluble dye and kept for sonication for 30 mins. After that 0.2 ml of the solution was pipetted out and poured on the fabric surface.

Mechanical grease: Grease has been purchased from motor shop and used directly to stain the fabric. 0.2 ml of the solution was pipetted out and poured on the fabric surface.

Sebum: 78 g of palmoline oil, 12 g of squalene and 10 g of distilled coconut fatty acid was mixed properly and 0.1 g of violet dye was added. The solution was kept for sonication and 0.2 ml of the solution was pipetted out and poured on the fabric surface.

All the stains were aged for 4 hours and then taken for washing.

Procedure for Treating Fabric:

1.35 ml of the test solution/formulation was added to the stained fabric and was kept in contact for 5 minutes and then was rinsed in a front loader washing machine at L/C (liquor/cloth) of 7:1 for 2 minutes in 24FH (Ca:Mg-2:1) water. Only a single rinse was provided. The cleaning evaluation was later done post drying the fabrics.

Fabrics were washed in front loader. 10 L of water taken in the machine. 24FH hardness was maintained by adding calculated amount of calcium chloride and magnesium chloride. A single rinse was provided to check the efficacy of the formulation. For Hand Wash 1 L of 24FH water was taken in a beaker. Stained swatches were dipped and given 10 rubs and one rinse to check the efficacy of the formulations.

Evaluation of Fabric:

SRI (stain removal index) was used to evaluate the efficacy of each formulation. After the washing, final L, a, b values were recorded by Artix Scanner and stain removal index was determined by following the equation:

SRI=100−(L_{bw}−L_{aw})²+(a_{bw}−a_{aw})₂+(b_{bw}−b_{aw})²

where, bw is before wash L, a, b values and aw is after wash L, a, b values.

Procedure and Test for Antimicrobial Benefit: EN 1276 B or European Suspension Test

The hygiene efficacy of the formulation was evaluated with an in-vitro bacterial plate test. Protocol: European Suspension Test (EST) or BS EN 1276 B

Test bacteria: Staphylococcus aureus ATCC 6538 (Gram-positive)
Escherichia coli ATCC 10536 (Gram-negative)
Pseudomonas aeruginosa ATCC 15442 (Gram-negative)

1) Bacteria:

The test bacteria were grown overnight at 37° C. on TSA plate. The grown culture colonies were suspended in 0.9% saline solution. The culture cell density was adjusted to get the final count of 1×10⁸ CFU/ml, based on a 620 nm optical density (OD) calibration chart (0.2 OD at 620 nm for S. aureus and, 0.8 OD at 620 nm for E. coli, and 0.5 OD at 620 nm for P. aeruginosa).

2) Procedure:
a) 8 ml of the test solution was taken in a sterile sample container (in this case the full formulation) and 1 ml of test culture with 1 ml of 0.3% or 3.0% (w/v) BSA or bovine serum albumin (protein) was added. Here, 0.3% BSA represents “Clean conditions” or low soil load, and 3.0% BSA represents “Dirty conditions” or high soil load. After the specified contact time of 5 minute, 1 ml of the above mixture was immediately neutralized in 9 ml Butterfield Phosphate buffer with neutralizers and plated on Tryptic Soy Agar in duplicates.
b) In case of control, 1 ml of the test culture was mixed with 1 ml of 0.3% BSA and 1 ml of 3.0% BSA added to 8 ml hard water, and was serially diluted and plated on TSA. After solidification, the plates were incubated at 37° C. for 48 hours, and the residual colonies were counted.
c) In the examples below, the reduction of bacteria is calculated in log colony forming units/ml (Log CFU/ml). In comparing log reduction value, the higher the value means more reduction of bacteria. For instance, any formulation without active or the untreated control will have 0 log reduction while for a formulation with any antimicrobial effect, the log reduction will be at least 0.5 or greater up to 7 logs.

The composition according to the invention should be superior in both cleaning and antimicrobial benefits.

### Example 1

Viscosity

TABLE 1

| | Comparative- 1 | Invention- A |
|---|---|---|
| 1,2 Octane diol | 1 | 0.5 |
| DiPropylene glycol n-butyl ether | 2.5 | 2.5 |
| Methyl laurate | 2.5 | 1.0 |
| Permulene TR2 | 0.12 | |
| Non-Ionic C12EO7 | 1.5 | 3.0 |
| SLES-2EO | | 1.0 |
| Texcare UL 50 | 1.04 | 1.04 |
| Dequest 2010 | | 1.0 |
| NaOH | 0.025 | |
| Sodium citrate | | 2.0 |
| 1,2 Propane diol | | 8.0 |
| Perfume- Safari Sake 4F | 0.2 | 0.2 |
| Water (balance) | 90.075 | 79.72 |
| pH | 7.1 | 4.5 |
| Viscosity (Brookfield Viscometer, | 112 Cp | 4.7 |
| LVDV Spindle 02) | | |

Comparative 1, having high viscosity, makes it difficult to process, (need high shear mixing) and customized nozzle design for consistent delivery of liquid (high cost-complex design).

### Example 2

Cleaning and Hygiene Performance

Cleaning evaluation of the formulations were carried out in front loader washing machine and by hand wash protocol by following the same procedure as discussed in method. The result is tabulated below.

TABLE 2

| | Comparative 01 | | Invention A | |
|---|---|---|---|---|
| Performance in Machine (FL) | | | | |
| Black tea | 90.1 | (±0.2) | 92.8 | (±0.12) |
| Garden Soil | 80.3 | (±0.41) | 83.9 | (±0.27) |
| Coffee with Milk | 97.2 | (±0.11) | 97.9 | (±0.14) |
| Performance in hand wash | | | | |
| Black tea | 91.60 | (±0.14) | 96.15 | (±0.17) |
| Garden Soil | 81.64 | (±0.41) | 87.59 | (±0.27) |
| Coffee with Milk | 95.43 | (±0.09) | 95.73 | (±0.12) |

TABLE 3

| | | Log removal | Log removal |
|---|---|---|---|
| | | E. Coli | S. Aurious |
| Comparative 01 | With CPC Clay | 7.96 (±0.2) | 5.12 (±0.12) |
| | Without CPC Clay | 7.96 (±0.1) | 1.25 (±0.2) |
| Invention A | | 6.83 (±0.12) | 5.05 (±0.08) |

### Antimicrobial Efficacy

### Example 3

Stability of the Formulation:

Stability of the formulation were carried out in both room temp (25 deg C.) and in Hot and dry condition (40 deg C., and 20% Relative humidity). The process was continued will 16^{th} week to check any physical separation. The phase separation as observed visually at different interval of time and noted accordingly in the below table.

TABLE 4

| | | Comparative | Invention |
|---|---|---|---|
| | | 1 | A |
| Room temp (25 deg C.) | Week 4 | Stable | Stable |
| | Week 8 | Stable | Stable |
| | Week 12 | Phase separated | Stable |
| | Week 16 | | Stable |
| Hot & Dry (40 deg C. & 20 RH) | Week 4 | Phase separated | Stable |
| | Week 8 | | Stable |
| | Week 12 | | Stable |
| | Week 16 | | Stable |

The formulation with permulene TR2 (comparative 01) was unstable due to presence of very less amount of surfactant. And it got phase separated at hot and dry condition. With addition of a combination of surfactant, stability issue got solved, performance on stain improved and it enabled us to add other benefit agents.

### Example 4

Gross Negative Test on Coloured Garment:

Gross negative test was performed on coloured garment. The coloured garments (black/blue/red/green) were procured form local shop. And cut into 10 cm*10 cm size. The same formulations were applied onto the fabric surface and kept for 5 min and then rinsed with water. SRI values were measured through artix scanner after drying.

TABLE 5

| | SRI | | | |
|---|---|---|---|---|
| | | | Comparative 1 | |
| | Water | Comparative 1 | w/o CPC Clay | Invention A |
| Black | 98.98 | 97.33 | 98.88 | 98.95 |
| Blue | 99.15 | 96.57 | 99.13 | 98.97 |
| Red | 98.61 | 98.17 | 98.59 | 97.58 |
| Green | 98.86 | 97.35 | 99.04 | 99.14 |

White patches observed with the comparative 01 formulation and also reflected in SRI values. Lower SRI means clay deposition on fabric which happened for comparative 01. When cpc clay was removed from comparative 01, the patching issue got solved however that leads to an unstable formulation.

### Example 5

Selection of Solvent Mix

To check the efficacy of each ingredient, model formulations were made as per Table 6 below, and the cleaning efficacy were evaluated both in wash scenario and with rinse.

TABLE 6

| | Wt. % | | | | | | | Wt. % |
|---|---|---|---|---|---|---|---|---|
| | Comparative | Comparative | Comparative | Comparative | Comparative | Comparative | Comparative | Invention |
| Ingredient | 02 | 03 | 04 | 05 | 06 | 07 | 08 | B |
| 1,2 Octanediol | | 1.67 | | | 1.67 | | 1.67 | 1.67 |
| Dipropylene glycol | | | 4.16 | | | 4.16 | 4.16 | 4.16 |
| n- butyl ether | | | | | | | | |
| Methyl laurate | | | | 4.16 | 4.16 | 4.16 | | 4.16 |
| perfume (safari | 0.20 | 0.20 | 0.20 | 0.20 | 0.20 | 0.20 | 0.20 | 0.20 |
| sake 4F) | | | | | | | | |
| Tex Care UL 50 | 1.00 | 1.00 | 1.00 | 1.00 | 1.00 | 1.00 | 1.00 | 1.00 |
| Dequest 2010 | 1.00 | 1.00 | 1.00 | 1.00 | 1.00 | 1.00 | 1.00 | 1.00 |
| Non-ionic C1EO7 | 5.00 | 5.00 | 5.00 | 5.00 | 5.00 | 5.00 | 5.00 | 5.00 |
| SLES-70% | 5.00 | 5.00 | 5.00 | 5.00 | 5.00 | 5.00 | 5.00 | 5.00 |
| Sodium citrate | 2.00 | 2.00 | 2.00 | 2.00 | 2.00 | 2.00 | 2.00 | 2.00 |
| Propane 1,2 diol | 8.00 | 8.00 | 8.00 | 8.00 | 8.00 | 8.00 | 8.00 | 8.00 |
| Water | 77.80 | 76.13 | 73.64 | 73.64 | 71.97 | 69.48 | 71.97 | 67.81 |

Cleaning Performance:

TABLE 7

| Comparative | Comparative | Comparative | Comparative | Comparative | Comparative | Comparative | Invention |
|---|---|---|---|---|---|---|---|
| 02 | 03 | 04 | 05 | 06 | 07 | 08 | B |

Performance with washing

| | | | | | | | | |
|---|---|---|---|---|---|---|---|---|
| Cooking Oil | 87.79 (0.29) | 87.95 (0.01) | 86.87 (0.40) | 87.26 (1.15) | 90.12 (0.10) | 88.49 (0.97) | 88.18 (0.34) | 91.53 (0.69) |
| Sebum | 88.79 (0.36) | 88.51 (0.15) | 89.56 (0.03) | 90.33 (0.82) | 89.88 (0.15) | 90.98 (0.46) | 89.31 (0.02) | 92.25 (0.20) |
| Mechanical | 87.42 (0.47) | 86.59 (2.52) | 85.74 (2.60) | 90.02 (1.12) | 91.29 (0.64) | 88.11 (0.08) | 86.93 (0.70) | 92.71 (0.27) |
| Grease | | | | | | | | |

Performance with only rinse

| | | | | | | | | |
|---|---|---|---|---|---|---|---|---|
| Cooking Oil | 84.39 (0.40) | 84.58 (0.11) | 80.64 (0.62) | 83.79 (0.49) | 85.05 (0.02) | 82.29 (0.58) | 83.39 (1.20) | 87.06 (0.54) |
| Sebum | 87.12 (0.01) | 87.2 (0.17) | 87.14 (0.28) | 87.72 (0.28) | 87.94 (0.71) | 88.75 (0.16) | 87.67 (0.07) | 90.13 (0.31) |
| Mechanical | 75.78 (0.37) | 73.44 (0.30) | 75.89 (1.52) | 77.56 (0.05) | 74.37 (1.22) | 77.86 (0.35) | 79.52 (0.20) | 81.22 (0.15) |
| Grease | | | | | | | | |

The above data indicates that when all three solvents are present in the formulation, superior stain removal is observed on stains caused by sebum stains, cooking oil, and mechanical grease. Similarly, the same was observed upon subjecting the substrate to a single rinse as opposed to full wash process, according to the method described earlier.

Anti-Microbial Efficacy:

Clean: Low Soil Load

TABLE 8

| | Pseudomonas aeruginosa | | Staphylococcus aureus | |
|---|---|---|---|---|
| | Avg. | Stdev. | Avg. | Stdev. |
| Comparative 02 | 0.81 | 0.18 | 1.52 | 0.1 |
| Comparative 03 | 6.36 | 1 | 1.99 | 0.47 |
| Comparative 04 | 6.85 | 0.31 | 2.34 | 0.18 |
| Comparative 05 | 0.83 | 0.15 | 1.57 | 0.07 |
| Comparative 06 | 6.1 | 1.09 | 2.31 | 0.21 |
| Comparative 07 | 6.13 | 1.25 | 2.93 | 0.56 |
| Comparative 08 | 6.25 | 1.17 | 2.6 | 0.65 |
| Invention B | 6.38 | 0.98 | 2.78 | 0.54 |

Dirty: High Soil Load

TABLE 9

| | Pseudomonas aeruginosa | | Staphylococcus aureus | |
|---|---|---|---|---|
| | Avg. | Stdev. | Avg. | Stdev. |
| Comparative 02 | 0.91 | 0.03 | 1.31 | 0.04 |
| Comparative 03 | 5.46 | 0.43 | 1.89 | 0.36 |
| Comparative 04 | 6.85 | 0.31 | 1.94 | 0.23 |
| Comparative 05 | 0.84 | 0.14 | 1.42 | 0.15 |
| Comparative 06 | 6.12 | 0.9 | 2.12 | 0.21 |
| Comparative 07 | 5.59 | 1.29 | 3.08 | 0.66 |
| Comparative 08 | 6.68 | 0.56 | 2.52 | 0.63 |
| Invention B | 6.95 | 0.17 | 2.56 | 0.51 |

The anti-microbial efficacy was found to be superior when only glycol ether is present. However, in presence of only methyl laurate the efficacy is lower. The efficacy restored when all the three solvents are present together.

### Example 6

Effect of Dequest 2010:

TABLE 10

| | % | % |
|---|---|---|
| Ingredient | Invention A | Comparative 9 |
| 1,2 Octanediol | 0.50 | 0.50 |
| Di(propylene glycol) n-butyl ether | 2.50 | 2.50 |
| Methyl laurate | 1.00 | 1.00 |
| perfume (safari sake 4F) | 0.20 | 0.20 |
| Tex Care UL 50 | 2.08 | 2.08 |
| Dequest 2010 | 1.00 | — |
| Galaxy NI | 3.00 | 3.00 |
| SLES-70% | 1.00 | 1.00 |
| Citric Acid | — | 1.00 |
| Sodium Citrate | 2.00 | 0.00 |
| 1,2 Propane di Ol | 8.00 | 10.00 |
| Water | 78.72 | 78.72 |

pH of the formulation Comparative 09, was maintained to 4, with addition of 1% Citric Acid. Cleaning evaluation was carried out on Black Tea, Coffee with Milk, and on Tomato ketchup.

Stain Aging Time—4 Hour

TABLE 11

| | Black Tea | | Coffee with Milk | | Tomato Ketchup | |
|---|---|---|---|---|---|---|
| | Avg. | Stdev | Avg. | Stdev | Avg. | Stdev |
| Fabric Type: | | | | | | |
| Cotton | | | | | | |
| Invention A | 92.09 | 1.26 | 91.97 | 0.00 | 91.80 | 0.08 |
| Comparative 09 | 91.68 | 0.31 | 89.22 | 0.21 | 89.10 | 0.46 |
| Fabric Type: | | | | | | |
| Polycotton | | | | | | |
| Invention A | 97.29 | 0.06 | 98.26 | 0.19 | 97.29 | 0.14 |
| Comparative 09 | 96.97 | 0.10 | 96.52 | 0.07 | 95.59 | 0.55 |

The difference of 2 SRI Unit is significant. The diff was there on stains caused by coffee with milk and on tomato ketchup stains.

Anti-Microbial Efficacy

TABLE 12

| | | Clean System | Dirty system |
|---|---|---|---|
| S. Aureus | Invention A | 4.59 (0.35) | 4.47 (0.39) |
| | Comparative 09 | 6.70 (0.05) | 6.70 (0.05) |
| | Comparative 9 | 1.82 (0.35) | 1.92 (0.38) |
| | (without citric acid) | | |
| E. Coli | Invention A | 6.79 (0.06) | 6.79 (0.06) |
| | Comparative 09 | 6.26 (0.69) | 6.79 (0.06) |
| | Comparative 09 | 5.72 (1.56) | 5.78 (1.48) |
| | (without citric acid) | | |

In terms of microbial kill, comparative 09 is very similar to invention A and in few cases slightly better, however in terms of cleaning efficacy, invention A is superior. Invention A is optimal in terms of cleaning and in antimicrobial efficacy.

### Example 7

Effect of Surfactant:

TABLE 13

| | % | % |
|---|---|---|
| Ingredient | Invention A | Comparative 11 |
| 1,2 Octanediol | 0.50 | 0.50 |
| BPP | 2.50 | 2.50 |
| Methyl laurate | 1.00 | 1.00 |
| perfume (safari sake 4F) | 0.20 | 0.20 |
| Tex Care UL 50 | 2.08 | 2.08 |
| Dequest 2010 | 1.00 | 1.00 |
| Galaxy NI | 3.00 | 6.00 |
| SLES-70% | 1.00 | — |
| Sodium Citrate | 2.00 | 2.00 |
| MPG | 8.00 | 8.00 |
| Water | 78.72 | 76.72 |

Formulation SDD 70, requires 6% Nonionic to get it stabilize, whereas, in SDD 60, only 35 NI and 1% SLES was enough to provide the stability.

TABLE 14

| Fabric Type: | Black Tea | | Coffee with Milk | | Tomato Ketchup | |
|---|---|---|---|---|---|---|
| Cotton | Avg. | Stdev | Avg. | Stdev | Avg. | Stdev |
| Invention A | 92.09 | 1.26 | 91.97 | 0.00 | 91.80 | 0.08 |
| Comparative 11 | 91.78 | 0.23 | 89.64 | 0.11 | 89.00 | 0.52 |

TABLE 15

| Fabric Type: | Black Tea | | Coffee with Milk | | Tomato Ketchup | |
|---|---|---|---|---|---|---|
| Polycotton | Avg. | Stdev | Avg. | Stdev | Avg. | Stdev |
| Invention A | 97.29 | 0.06 | 98.26 | 0.19 | 97.29 | 0.14 |
| Comparative 11 | 98.68 | 0.11 | 97.41 | 0.13 | 94.80 | 0.12 |

Again, the differences, were found on coffee with milk on woven cotton and tomato ketchup in both the fabric type.

### Example 8

Comparing C₇₋₁₀ Diols to Other Diols.

TABLE 16
S. Aureous

| | | Log Reduction | |
|---|---|---|---|
| | | Low Soil Load | High Soil Load |
| | | CLEAN | DIRTY |
| Comparative 11 | 2% 1,2-Ethanediol | 0.370 | 0.438 |
| Comparative 12 | 2% 1,2-Propanediol | 0.385 | 0.342 |
| Comparative 13 | 2% 1,2-Butanediol | 0.325 | 0.355 |
| Comparative 14 | 2% 1,2-Pentanediol | 0.195 | 0.259 |
| Comparative 15 | 2% 1,2-Hexanediol | 0.094 | 0.186 |
| Invention A | 2% 1,2-Heptanediol | 0.568 | 0.517 |
| Invention B | 2% 1,2-Octanediol | 6.209 | 6.176 |
| Invention C | 2% 1,2-Nonanediol | 1.603 | 1.740 |
| Invention D | 2% 1,2-Decanediol | 0.468 | 0.463 |

TABLE 17
E. Coli

| | | Log Reduction | |
|---|---|---|---|
| | | Low Soil Load | High Soil Load |
| | | CLEAN | DIRTY |
| Comparative 11 | 2% 1,2-Ethanediol | 0.230 | 0.325 |
| Comparative 12 | 2% 1,2-Propanediol | 0.105 | 0.190 |
| Comparative 13 | 2% 1,2-Butanediol | 0.080 | 0.115 |
| Comparative 14 | 2% 1,2-Pentanediol | 0.130 | 0.100 |
| Comparative 15 | 2% 1,2-Hexanediol | 0.025 | 0.165 |
| Invention A | 2% 1,2-Heptanediol | 1.050 | 0.540 |
| Invention B | 2% 1,2-Octanediol | 7.175 | 7.175 |
| Invention C | 2% 1,2-Nonanediol | 7.500 | 7.500 |
| Invention D | 2% 1,2-Decanediol | 6.920 | 6.743 |

1. A fabric treatment composition comprising:
1 to 35% by weight of a solvent system comprising:
2 to 66% by weight of a glycol ether;
0.8% to 25% by weight of a diol which is a vicinal diol with carbon chain length from C₇ to C₁₄;
2% to 66% by weight of a fatty acid ester of the formula R¹C(═O)OR² wherein R¹ represents an alkyl group having 6 to 15 carbon atoms and R² is preferably a methyl or ethyl;
0.25% to 10% by weight of an alkoxylated C₈₋₁₈ anionic surfactant;
0.75% to 27% by weight of a nonionic surfactant selected from alkoxylated alkanols in which the alkanol comprises 6 to 20 carbon atoms and wherein the number of moles of C₂₋₃ alkylene oxide is from 5 to 20;
0.1% to 20% by weight of a hydrotropes selected from the group consisting of 1,2 propanediol, polypropylene glycol or combinations thereof;
0.1% to 2% by weight of a phosphonate based sequestrant;
0.5% to 2% by weight of sodium citrate; and
water,
wherein the composition has a pH ranging from 2.5 to 5.0.

2. The fabric treatment composition according to claim 1, wherein the glycol ether is selected from the group consisting of dipropylene glycol n-butyl ether, dipropylene glycol dimethyl ether, or dipropylene glycol methyl ether acetate.

3. The fabric treatment composition according to claim 1, wherein the diol is 1,2 octanediol.

4. The fabric treatment composition according to claim 1, wherein the fatty acid ester is methyl laurate.

5. The fabric treatment composition according to claim 1, wherein the anionic surfactant is an alkoxylated anionic surfactant comprising: an alkyl group with carbon chain length C8 to C18 and having 1 to 30 moles of alkylene oxide.

6. The fabric treatment composition according to claim 1, wherein the nonionic surfactant is selected from an alkoxylated linear alcohol.

7. The fabric treatment composition according to claim 1, wherein the composition comprises 39.9-98.9% by weight of water.

8. The fabric treatment composition according to claim 1, wherein the sequestrant is selected from the group consisting of 1-hydroxyl ethylidene-1,1-diphosphonic acid, 1-hydroxyl ethylidene-1,1-diphosphonic acid sodium salt, ethylidenediamine tris(methylene phosphonic acid, hydroxyethylidene-1,1-diphosphonic acid, or tetrasodium salt.

9. The fabric treatment composition according to claim 1, wherein the composition has a pH ranging from 2.5 to 4.0.

10. A method for treating a fabric comprising the steps, in sequence, of:
applying the composition according to claim 1 onto the fabric;
rinsing the fabric with water at least once; and
allowing the fabric to dry.

11. (canceled)

12. A method for treating a fabric comprising:
obtaining a fabric treatment composition comprising:
1 to 35% by weight of a solvent system comprising:
2 to 66% by weight of a glycol ether;
0.8% to 25% by weight of a vicinal diol with carbon chain length from C₇ to C₁₄;
2% to 66% by weight of a fatty acid ester of the formula R¹C(═O)OR² wherein R¹ represents an alkyl group having 6 to 15 carbon atoms and
R² is preferably a methyl or ethyl; and
0.25% to 10% by weight of an alkoxylated C₈-18 anionic surfactant;
0.75% to 27% by weight of a nonionic surfactant selected from alkoxylated alkanols in which the alkanol comprises 6 to 20 carbon atoms and wherein the number of moles of C₂-3 alkylene oxide is from 5 to 20;
0.1% to 20% by weight of a hydrotrope selected from the group consisting of 1,2 propanediol, polypropylene glycol or combinations thereof;
0.1% to 2% by weight of a phosphonate based sequestrant;
0.5% to 2% by weight of sodium citrate; and
water,
applying a sufficient amount of the fabric treatment composition to deliver antimicrobial benefits to the fabric.
